(19) United States
(12) Patent Application Publication
(10) Pub. No.: US 2015/0375668 A1
(43) Pub. Date: Dec. 31, 2015

(54) COMMERCIAL VEHICLE HAVING A MODULAR BODY

(71) Applicant: SH2M, Pont de Cheruy (FR)

(72) Inventor: Pierre MILLET, LA CHAPELLE DE LA TOUR (FR)

(21) Appl. No.: 14/767,943

(22) PCT Filed: Nov. 5, 2013
(86) PCT No.: PCT/FR2013/052635

§ 371 Date: Aug. 14, 2015

(30) Foreign Application Priority Data
Feb. 20, 2013 (FR) 1351458

(51) Int. Cl. B60P 1/64

(52) U.S. Cl. CPC B60P 1/6409; B60P 1/6418

(57) ABSTRACT

A vehicle comprises a chassis defining a cabin and a platform for receiving a removable body having a front part, a rear part, two side parts and a bottom having two bearing surfaces for the forks of a handling device, extending mutually parallel and partly defining two forklift pockets, the vehicle comprising a temporary assembly device between the chassis and the body. The body includes two forklift pockets leading to the rear part of the body. A temporary assembly device includes, for each forklift pocket, a locking lever pivotably mounted on the chassis and operated in one direction to occupy a retracted position releasing the assembly between the body and the chassis and operated in an opposite direction to occupy a position of assembly of the body with the chassis and a locking system between the body and the chassis and which includes a control with secure access.

The present invention relates to the technical field of commercial vehicles in the general sense and more particularly pertains to a commercial vehicle comprising a cabin and a removable body.

In the technical field of the invention, from the patent GB 2 110 171, a commercial vehicle is known comprising a cabin and a chassis for receiving a frame or body forming a van removably mounted on the chassis. For this purpose, the chassis is equipped with two cross members open from above to form seats for receiving profiles of complementary shape fastened under the bottom of the van. The profiles delimit a pocket for the forks of a forklift truck intended to bear against the bottom of the van during operations of removing the van or fitting the van onto the chassis. Pins protrude from the cross members in order to cooperate with lights built into the formed sections to prevent movement of the van in relation to the chassis. The assembly of the van on the chassis can be completed using links fastened to the ends of the cross members.

Such a solution offers the advantage of making it possible to easily position or withdraw a van from the chassis of a commercial vehicle using a forklift truck, widespread in companies where such a vehicle is used.

However, the mounting of the van on the chassis does not provide a total guarantee of safety. Specifically, no mechanical lock is involved between the chassis and the van. Moreover, the technique of fitting the fastening links is a stopgap solution requiring manual intervention and which moreover does not guarantee the safe and effective fastening of the van onto the chassis.

It must moreover be noted that such a van can be easily removed from the vehicle by a malicious individual equipped with a forklift truck.

Additionally, the technical means providing the assembly between the van and the chassis in practice turn out to be especially adapted to a particular model of van, limiting the applications of such a commercial vehicle.

The subject of the invention therefore has the aim of remedying the drawbacks of the prior art by proposing a new commercial vehicle capable of allowing easy and safe mounting of a removable body on the chassis of such a vehicle.

Another subject of the invention is to propose a commercial vehicle designed to allow simple, rapid and safe adaptation of different models of body to perform different functions.

To achieve these objectives, the vehicle according to the invention consists of a chassis defining a cabin and a platform for receiving a removable body, having a front part, a rear part, two side parts and a bottom having two bearing surfaces for the forks of a handling device, extending mutually parallel and partly defining two forklift pockets, the vehicle comprising a temporary assembly device between the chassis and the body.

According to the invention:
the body comprises two forklift pockets leading to the rear part of the body,
the temporary assembly device comprises:
   for each forklift pocket, a locking lever pivotably mounted on the chassis and operated in one direction to occupy a retracted position releasing the assembly between the body and the chassis and operated in an opposite direction, to occupy a position of assembly of the body with the chassis,
   a locking system between the body and the chassis, comprising a control with secure access.

In addition, the vehicle according to the invention can further have in combination at least one and/or the other of the following additional features:
the body is laid out to form a tank, an insulated or uninsulated van, a flatbed with or without drop sides, a tipper flatbed,
the locking levers extend in protrusion inside the forklift pockets in such a way as to controlled, using the forks, to pivot to occupy the retracted position, the levers being elastically stressed to occupy, in the absence of the forks, a position of assembly of the body with the chassis,
the control with secure access of the locking system is located inside the cabin,
the control of the central locking system controls the displacement of a slide ensuring the body is blocked in the lifted position,
the slide acts on an end stop of the body extending substantially in the middle of the front part of the body,
each locking lever comprises a hook co-operating, in the rest position, with a horizontal rod carried by the bottom of the body,
each hook is extended in the direction of the end part of the lever, by an inclined actuating bar,
each lever is equipped with a cut-off head, pivotably mounted on the lever and elastically returned in the direction of the front part of the body,
the body is equipped on its rear part, with on its rear part, flaps for closing the forklift pockets.

Another subject of the invention is an item of modular transport equipment, comprising:
a vehicle according to the invention,
at least one removable spare body capable of being mounted on the chassis of the vehicle and having a front part equipped at its middle, with an end stop co-operating with the locking system of the vehicle, a rear part into which two forklift pockets open, two side parts, a bottom having two bearing surfaces for forks extending mutually parallel partly defining the two forklift pockets each equipped with a horizontal rod cooperating with a locking lever, the spare removable body and the removable body with which the vehicle is equipped being different models chosen from among a tank, an insulated or uninsulated van, a flatbed with or without drop sides, a tipper flatbed,
a handling device with two forks, controlled to lift the removable body off the vehicle and replace it by a spare removable body.

Various other features become apparent upon reading the description given below for the appended drawings which show, by way of non-limiting example, a number of forms of embodiment of the subject of the invention.

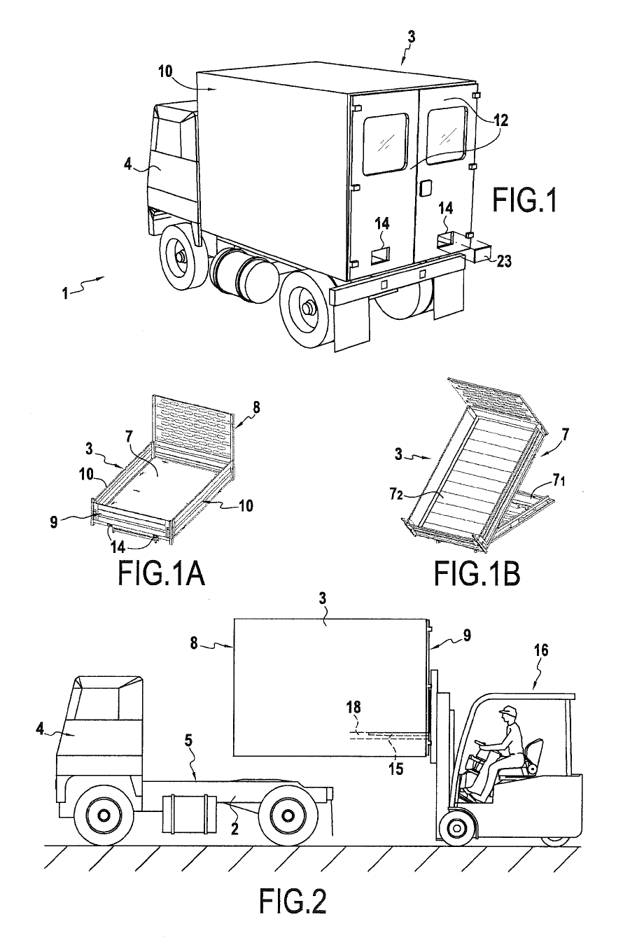

FIG. 1 is a perspective view of an exemplary embodiment of a commercial vehicle according to the invention.

FIGS. 1A and 1B are views of an exemplary embodiment of a removable cabin intended to equip a commercial vehicle according to the invention, of the type of a tilting flatbed with drop sides in the rest and tilted positions respectively.

FIG. 2 is a view illustrating the principle of the commercial vehicle in the process of being used by a removable body.

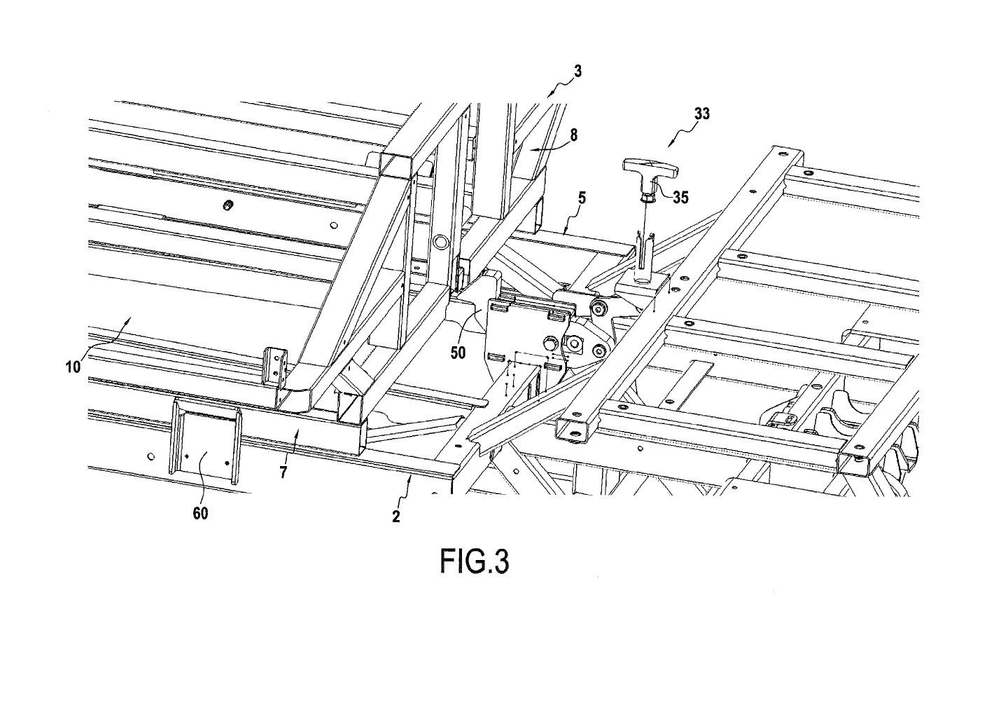

FIG. 3 is a partial perspective view illustrating an exemplary embodiment of a front locking system between the body and the chassis comprising a control with secure access.

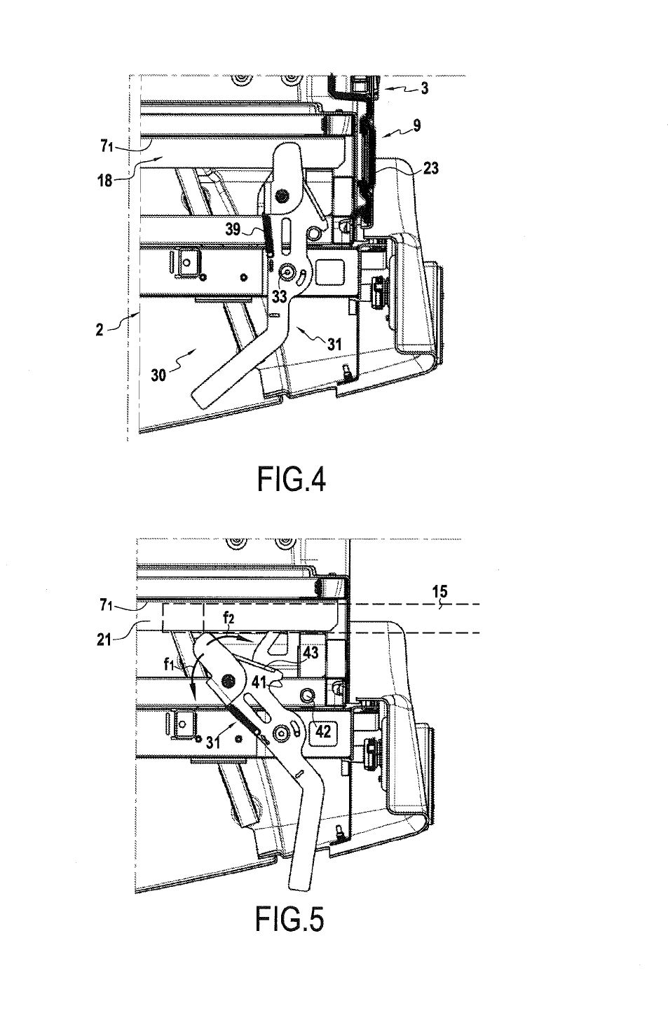

FIGS. 4 and 5 are views of a locking lever in accordance with the invention in the assembly and retraction positions respectively.

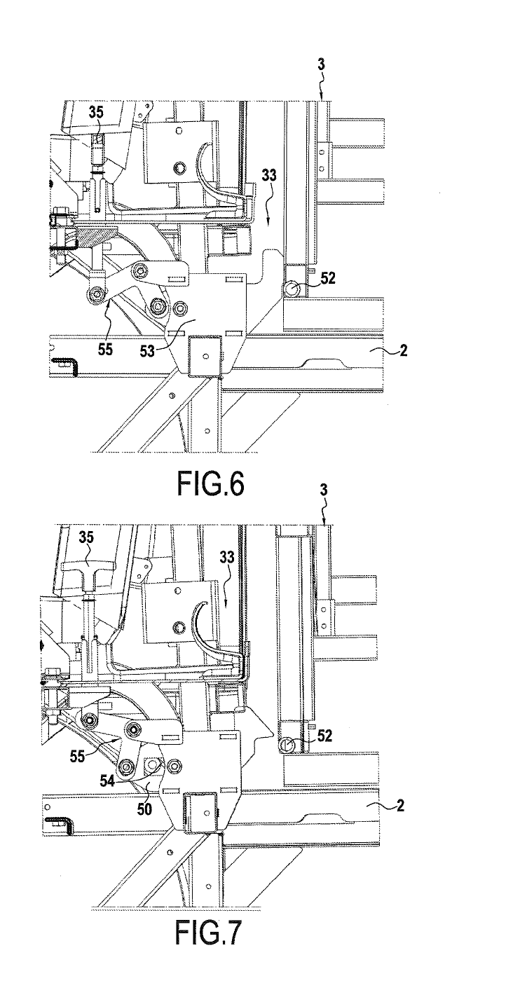

FIGS. 6 and 7 are detail views illustrating the front locking system between the removable body and the chassis in the locked and unlocked positions respectively.

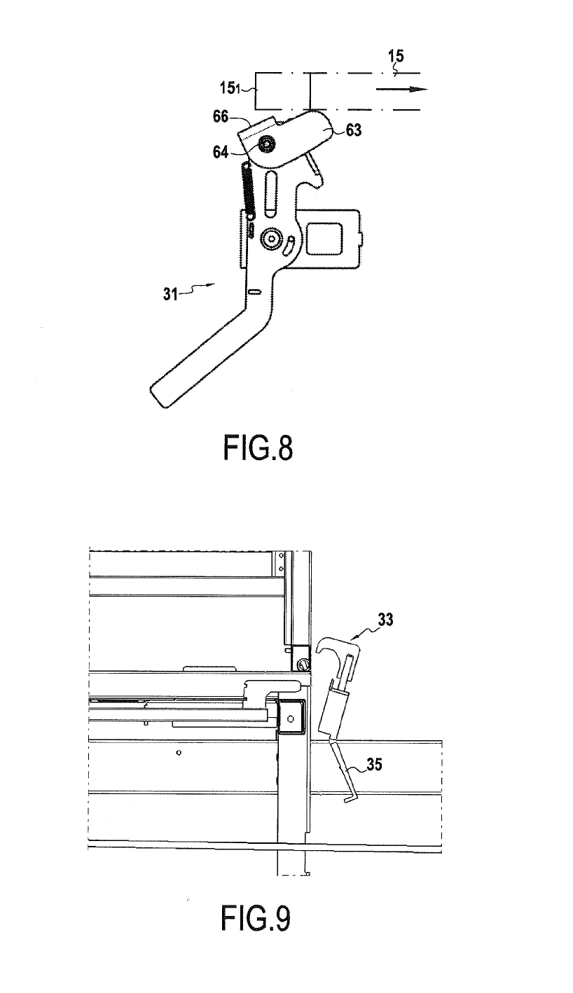

FIG. 8 is a detail view of a locking lever equipped with a cut-off system for cross members carried by forks.

FIG. 9 illustrates another exemplary embodiment of a front locking system between the body and chassis.

As is apparent from FIGS. 1 and 2, the subject of the invention relates to a commercial vehicle 1 comprising a chassis 2 and at least one removable body 3. The chassis 2 is suitable for defining a driver cabin 4 and a loading or receiving platform 5 for the removable body 3. The vehicle 1 which is, for example, of the front cabin type, comprises motorization of all types and preferably electric, as well as driving members in numbers suitable for the caliber of the vehicle.

In accordance with an advantageous embodiment feature, the commercial vehicle 1 is capable of receiving removable bodies 3 for different models. Thus, the subject of the invention addresses an item of modular transport equipment comprising a commercial vehicle 1 equipped with a removable body 3 for a given model and at least one so-called spare removable body for a preferred model different to the body with which the vehicle is equipped. By way of example, removable bodies 3 likely to equip the commercial vehicle 1 are models chosen from among a tank van, an insulated or uninsulated van, a van with solid walls or a shutter, a flatbed with or without drop sides, stationary or tilting, a tipper flatbed, a covered or grated item of body equipment etc. In the example illustrated in FIG. 1, the removable body 3 is a van whereas in the example illustrated in FIGS. 1A and 1B, the removable body is a tilting flatbed with drop sides.

Whatever the model, the removable body 3 comprises a bottom 7 having a rectangular shape corresponding to the shape of the receiving platform 5. Generally, each removable body 3 has a front part 8, a rear part 9 and two side parts 10. Of course, the different parts of the body 1 are produced according to the model manufactured. In the example illustrated in FIG. 1, the removable body 3 is a van such that the side parts 10, front part 8 and rear part 9 are formed by solid walls attached at their summits by a roof. Doors 12 are formed in the rear part 9 to access the inside of the van. Note that the bottom 7 is provided with cross members and/or rails adapted to bear on determined areas of the platform 5 of the chassis 2. In the example illustrated in FIG. 1A, 1B, the bottom 7 is provided with a stationary chassis 7₁ intended to bear on the platform 5 and a flatbed with drop sides 7₂ tiltably mounted on the chassis 7₁.

According to a feature of the invention, the rear part 9 of the body 3 comprises two openings 14 for the forklift pockets 15 of a handling device 16 such as a forklift truck for example. The openings 14 communicate with pockets 18 for the forks 15, partly defined by bearing surfaces 7₁, represented by the bottom 7 of the body. The two pockets 18 extend mutually parallel along the longitudinal direction of the removable body 3. Note that the distance between the two pockets 18 corresponds to the distance separating the two forks 15 of the handling device 16 or the two fork extensions added to the forks of the handling device. These two forks 15 are capable of coming into contact with the bearing surfaces 7₁ of the removable body 3. Regarding this, the bottom 7 is laid out to have, locally or over the whole length of the pockets 18, a bearing surface 7₁ for the forks. Of course, the pockets 18 are suitable for receiving different models of forks.

In a preferred variant embodiment, each pocket 18 comprises on either side, along the longitudinal direction, end stops 21 providing the lateral guidance of the forks 15. Advantageously, end stops 21 are positioned on either side of each opening 14 to make it possible to guide the engagement of the forks 15 inside the pockets 18. These end stops 21 preferably extend over most of the length of the pockets 18 which are thus circumscribed within a duct or a tunnel.

According to an advantageous embodiment feature, the removable body 3 is equipped, on its rear face, with flaps 23 for closing the openings 14. Each flap 23 is mounted on the removable body 3 in an appropriate manner. For example, the flaps 23 are removably mounted on the body by clipping on.

The commercial vehicle 1 according to the invention also comprises a device 30 for unlockable or temporary assembly of the body 3 with the chassis 2.

In accordance with the invention, the temporary assembly device 30 comprises:
for each forklift pocket 18, a locking lever 31 pivotably mounted on the chassis 2 and operated in a first direction F1 to occupy a retracted position releasing the assembly between the removable body 3 and the chassis (FIG. 5) and operated in a second direction F2 opposite to the first direction F1, to occupy a position of assembly of the removable body 3 with the chassis 2 (FIG. 4),
a locking system 33 between the body 3 and the chassis 2 comprising a control with secure access 35 (FIG. 3, 6).

In a preferred variant embodiment, the locking levers 31 are pivotably controlled using the forks 15. For this purpose, the locking levers 31 extend in the position of assembly of the body with the chassis, protruding inside the forklift pockets 18. Thus, when the forks engage 15 inside the forklift pockets 18, the locking levers 31 are made to pivot in the first direction F1 to occupy their retracted position. When the forks 15 are removed from the pockets 18, the locking levers 31 are elastically stressed to occupy, in the absence of the forks 15, a position of assembly of the removable body 3 with the chassis 2.

In the example illustrated, each locking lever 31 is pivotably mounted about an axis of pivot 33 carried by the chassis to allow the movement of the locking lever 31 in a substantially vertical plane. Each locking lever 31 is elastically stressed using a spring 39 to return to its assembly position. Each locking lever 31 comprises a hook 41 co-operating, in the rest position, with a horizontal rod 42 carried by the bottom 7 of the body 3.

Preferably, each locking lever 31 comprises, between the hook 41 and the end part, an actuating bar 43 which, when a vertical force is applied, enables the pivoting of the locking lever 31 in the first direction F1 to position the rod 42. Note that the end of each locking lever 31 is offset toward the front part 8 in relation to the axis of pivot 33.

Preferably, the locking levers 31 are mounted close to the rear of the chassis 2 of the commercial vehicle.

The so-called front locking system 33 comprises a slider 50 the movement of which can be controlled using the control 35 which for example has a quarter-turn position to secure the lock. The slider 50 can be moved between a position for blocking the body in a lifted position (FIG. 6) and a position of unlocking of the body 3 (FIG. 7). Advantageously, the slider 50 is capable of blocking an end stop 52 extending in the middle and at the base of the front part 8 of the body 3. The slider 50 is slidably mounted in a guide housing 53 and is elastically stressed by a spring 54, in a direction leading to the exit of the slider 50 from the guide housing 53. The spring 54 stresses the slider 50 in a bearing position against the end stop 52 to ensure the locking of the removable body 3 on the body 2. The slider 50 is moved between the two positions using the control 35 via a transmission 55 of any type.

The operation of the transport follows on directly from the previous description.

In the position in which the body 3 is assembled on the vehicle, the body is locked onto the chassis 2 using the two locking levers 31 and the front locking system 33. The removable body 3 is thus rigidly anchored to the chassis at three points.

The removal of the removable body 3 from the vehicle chassis 2 consists in retracting the access flaps 23 to allow the introduction of the forks 15 of the handling device 16 into the openings 14. The engagement of the forks 15 in the pockets 18 leads to the pivoting of the locking levers 31 so that they occupy their retracted position wherein the rods 42 of the body are no longer retained by the hooks 41. The control with secure access 35 is also moved to make it possible to unlock the removable body 3 from the chassis. The handling device 16 is controlled to allow the lifting of the forks 15, bringing them in contact on the bearing surface 7₁ to allow the lifting of the removable body 3 and its withdrawal from the chassis 2.

The installation of a spare body 3 consists in raising the flaps of this body to allow the engagement of the forks 15 of the handling device 16 in the openings 14 so that they extend into the pockets 18 beneath the bottom 7 of the body. The elevation of the forks 15 makes it possible to lift the body 3 via their bearing on the bearing surface 7₁ of the bottom 7 of the body.

The handling device 16 moves the body to make it overhang the platform 5 of the chassis 2 and set it down on the platform 5. The positioning of the spare body is ensured by the presence of positioning buffers or bezels 60 rising up from the platform 5 of the chassis 2 and co-operating with the side parts 10 of the bottom of the body 3.

In this position, the locking levers 31 are tilted and occupy their retracted position. The withdrawal of the forks 15 from the pockets 18 triggers the pivoting of the locking levers 31 in the second direction of pivot under the action of the springs 39. The hooks 41 thus cooperate with the rods 42 of the chassis to lock the body 3 onto the chassis 2.

The control with secure access 35 of the locking system 33 is controlled to make the slider 50 co-operate with the end stop 52 of the body 3. Thus, the body 3 is then anchored at three points of the chassis 2. The body 3 is then rigidly fastened to the chassis 2 while having been lifted quickly and in perfect safety. A commercial vehicle 1 can thus be quickly equipped with a different model of body, according to the requirements of the users.

In a variant embodiment, note that the forks 15 of the handling device 16 can be fitted in certain cases with extensions connected at their end by a cross member 15₁ (FIG. 8). In this case, each locking lever 31 is equipped with a cut-off head 63 pivotably mounted on the lever 31 along an axis of pivot 64 and elastically returned using a spring 65, in the direction of the front part 8 of the body 3. This cut-off head 63 thus extends all the way to the free end of each locking lever 31.

This cut-off head 63 is able to be pivoted under the action of the cross member 15₁ of the forks 15, when the forks 15 are retracted. The pivoting of the cut-off head 63 thus permits the withdrawal of the forklift pockets 18. After the withdrawal of the forklift pockets 15, the cut-off head 63 is stressed by the spring 65 to return to its rest position defined by an end stop 66 coming into contact with the lever 31.

In the example illustrated, the malicious removal of the body 3 from the vehicle is prevented by the mounting of the control 35 inside the cabin 4 access to which is permitted to the individual generally provided with a key or else a swipe card. Of course, the securing of the locking system 33 can be increased by directly equipped the control 35 of the locking system 33 using a code blocking device, a key or swipe card for example. Note that such a blocking device can equip the locking system 33 the control of which is placed outside the driver's cabin 4 as illustrated in FIG. 9. In this case, provision can be made of the control 35 to be located outside the cabin 4 while being equipped with such a secure access blocking device.

In the previous description, the temporary assembly device 30 comprises two locking levers 31. It is obvious that it can be envisioned to position a greater number of assembly levers 31 at the forklift pockets 18.

In another variant embodiment, note that it is possible to envision controlling the operation of the locking levers 31, not using the forks 15 of a handling device, 16, but using a motor-driven system, for example an external control activate by an operator.

The invention is not limited to the examples described and represented as various modifications can be made thereto without departing from its scope.

1- A vehicle comprising a chassis (2) defining a cabin (4) and a platform (5) for receiving a removable body (3) having a front part (8), a rear part (9), two side parts (10) and a bottom (7) having two bearing surfaces (7₁) for the forks of a handling device (16), extending mutually parallel and partly defining two forklift pockets (18), the vehicle comprising a temporary assembly device (30) between the chassis (2) and the body (3), characterized in that:
the body (2) comprises two forklift pockets (18) leading to the rear part (9) of the body (3),
the temporary assembly device (30) comprises:
for each forklift pocket (18), a locking lever (31) pivotably mounted on the chassis (2) and operated in one direction to occupy a retracted position releasing the assembly between the body and the chassis and operated in an opposite direction, to occupy a position of assembly of the body (3) with the chassis (2),
a locking system (33) between the body (3) and the chassis (2), comprising a control with secure access (35).

2- The vehicle according to claim 1, characterized in that the body (3) is laid out to form a tank, an insulated or uninsulated van, a flatbed with or without drop sides, or a tipper bed.

3- The vehicle according to claim 1, characterized in that the locking levers (31) extend in protrusion inside the forklift pockets (18) in such a way as to be controllable, using the forks (15), to pivot to occupy the retracted position, the levers being elastically stressed to occupy in the absence of the forks (15), a position of assembly of the body with the chassis.

4- The vehicle according to claim 1, characterized in that the control with secure access (35) of the locking system (33) is located inside the cabin (4).

5- The vehicle according to claim 4, characterized in that the control (35) of the locking system (31) controls the movement of a slide (50) ensuring the body is blocked in the lifted position.

6- The vehicle according to claim 5, characterized in that the slide (50) acts on an end stop (52) of the body extending substantially in the middle of the front part (8) of the body (3).

7- The vehicle according to claim 1, characterized in that each locking lever (31) comprises a hook (41) co-operating, in the rest position, with a horizontal rod (42) carried by the bottom (7) of the body (3).

8- The vehicle according to claim 7, characterized in that each hook (41) is extended in the direction of the end part of the lever, by an inclined actuating bar (43).

9- The vehicle according to claim 7, characterized in that each lever (31) is equipped with a cut-off head (63), pivotably mounted on the lever and elastically returned in the direction of the front part of the body.

10- The vehicle according to claim 1, characterized in that the body (3) is equipped on its rear part (9) with flaps (23) for closing the forklift pockets (18).

11- An item of modular transport equipment, characterized in that it comprises:
a vehicle (1) in accordance with claim 1,
at least one removable spare body (3) capable of being mounted on the chassis (2) of the vehicle and having a front part (8) equipped at its middle, with an end stop (52) co-operating with the locking system (33) of the vehicle, a rear part (9) into which two forklift pockets (18) open, two side parts (10), a bottom (7) having two bearing surfaces (7₁) for forks (15) extending mutually parallel partly defining the two forklift pockets each equipped with a horizontal rod (42) cooperating with a locking lever (31), the spare removable body (3) and the removable body (3) with which the vehicle (1) is equipped being different models chosen from among a tank, an insulated or uninsulated van, a flatbed with or without drop sides, or a tipper flatbed,
a handling device (16) with two forks (15), controlled to lift the removable body off the vehicle (1) and replace it by a spare removable body.
